(19) United States
(12) Patent Application Publication
(10) Pub. No.: US 2009/0037866 A1
(43) Pub. Date: Feb. 5, 2009

(54) ALTERNATING PHASE SHIFT MASK OPTIMIZATION FOR IMPROVED PROCESS WINDOW

(75) Inventors: Ioana C. Graur, Poughkeepsie, NY (US); Donald J. Samuels, Silverthorne, CO (US); Zachary Baum, Gardiner, NY (US); Lars W. Liebmann, Poughquag, NY (US)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: INTERNATIONAL BUSINESS MACHINES CORPORATION, Armonk, NY (US)

(21) Appl. No.: 11/833,462

(22) Filed: Aug. 3, 2007

(51) Int. Cl. G06F 17/50

(52) U.S. Cl. 716/19

(57) ABSTRACT

A method for designing alternating phase shift masks is provided, in which narrow phase shapes located between densely spaced design shapes are colored to allow a maximum amount of light transmission. After assigning and ensuring binary legalization of the phase shapes, the narrow phase shapes are assigned a color, such as 0° phase shift, that allows the more light transmission than the alternate or opposite color (e.g. 180° phase shift), which helps avoid printing errors such as resist scumming between closely spaced shapes, and maximizes the lithographic process window.

### FIELD OF THE INVENTION

The present invention broadly relates to the design of integrated circuits, and more particularly to design improvements of alternating phase shift mask layouts to achieve improved process window.

### BACKGROUND

In the manufacture of integrated circuits, photolithographic processes are commonly used, in which a wafer is patterned by projecting radiation through a patterned mask to form an image pattern on a photo sensitive material, referred to as a photoresist, or simply resist. The exposed resist material is developed to form openings corresponding to the image pattern, and then the pattern is transferred to the wafer substrate by methods such as etching, as known in the art.

The basic lithography system consists of a light source, a stencil, or photomask containing the pattern to be transferred to the wafer, a collection of lenses, and a means for aligning existing patterns on the wafer with patterns on the mask. Since a wafer containing from fifty to one hundred chips is patterned in steps of one to four chips at a time, a lithography stepper is limited by parameters described in Rayleigh's equation:

$$R = {k}_{1} \frac{λ}{NA} \qquad ( 1 )$$

where λ is the wavelength of the light source used in the projection system and NA is the numerical aperture of the projection optics used. k₁ is a factor describing how well a combined lithography system can utilize the theoretical resolution limit in practice and can range from 0.8 down to 0.5 for standard exposure systems. The highest resolution in optical lithography is currently achieved with deep ultra violet (DUV) steppers operating at 248 nm wavelength. Steppers operating at a wavelength of 356 nm are also in widespread use.

Patterning densely spaced geometries, as for example, a static random access memory (SRAM) cell and other process sensitive 2-D geometries for increasingly smaller technologies, e.g. 65 nm technologies or smaller, presents a major challenge. The use of resolution enhancement technologies (RET), such as alternating phase shift mask (altPSM) and advanced Optical Proximity Correction (OPC), have lead to improvements in the design patterns that may be reliably transferred to a wafer. However, obtaining high yield is a continuing challenge, for example, with occasional bridging occurring, in particular, in the SRAM cell, and in small spaces between landing pads. Such bridging is considered to be a catastrophic failure.

The quality with which small images can be replicated in lithography depends largely on the available process latitude; that is, the amount of allowable dose and focus variation that still results in correct image size. Phase shifted mask (PSM) lithography improves the lithographic process latitude or allows operation of a lower k₁ value (see equation 1) by introducing a third parameter on the mask. The electric field vector, like any vector quantity, has a magnitude and direction, so in addition to turning the electric field amplitude on and off, the phase of the vector can be changed. This phase variation is achieved in PSM's by modifying the length that a light beam travels through the mask material. By recessing the mask by the appropriate depth (to form a 180° colored phase shape), light traversing the thinner portion of the mask and light traversing the thicker portion of the mask (referred to as a 0° colored phase shape) will be 180° out of phase; that is, their electric field vectors will be of equal magnitude but point in exactly opposite directions so that any interaction between these light beams results in perfect cancellation. The limits of PSM lithography can be uniquely challenged by the manufacture of densely packed devices such as advanced Dynamic Random Access Memory (DRAM) or SRAM technologies. These technologies are entering development cycles with immediate requirements for sub-quarter micron printed gate lengths and tight dimensional control on the gate structures across large chip areas. Since these logic technologies are based on shrinking the gate length in an established memory array technology, the overall layout pitch remains constant for all critical mask levels, resulting in narrow, optically isolated lines on the scaled gate level. The requirement for tight line width control on narrow isolated lines drives the requirement of altPSM's for these logic applications. AltPSM lithography makes use of contrast enhancement caused by a phase transition under an opaque feature on a mask. This phase transition is achieved by etching an appropriate depth into the quartz mask substrate on one side of a narrow line structure on the mask. Since the 180° phase transition forces a minimum in the image intensity, narrow dark lines will be printed by these excess phase edges. Currently, the unwanted images are erased using a trim mask, a second mask that transmits light only in regions left unexposed by the residual phase edge.

However, the layout of phase shapes pose challenges for the lithographic process latitude or allowable process window. Applicants have observed that in tight spaces, where there is room for only a narrow phase shape, bridging will tend to occur when a 180° phase shape is inserted as opposed to a 0° phase shape. The difference in transmission between phases is sufficient in such process sensitive locations to make the desired image features un-resolvable. In addition, 180° phase shapes require additional processing at the mask house, which leads to additional challenges in quality control. Conventional software tools for designing altPSM mask layouts assign a “color” to phase shapes, for example, a phase shift of 0° or 180°, arbitrarily. Thus without intervention, the bridging is going to occur each time the color is assigned a 180° phase shift for tight spaces.

In addition to avoiding catastrophic failure, in the interest of yield, there is a need to control the dimension of critical features, in particular in densely packed technologies, as for the SRAM cell. The challenge of doing so for the sub-ground rule conditions present in such cells justifies special attention to the way the phase assignment takes place in altPSM technologies.

In view of the above, there is a need for an altPSM mask design methodology that results in manufacturable phase shape coloring.

### SUMMARY OF THE INVENTION

The present invention provides a method and computer program product for designing an alternating phase shift mask (altPSM) comprising: providing a design layout comprising a plurality of design shapes having a critical dimension to be printed on a substrate; providing an altPSM layout comprising at least one phase shape disposed between two of said plurality of design shapes, said at least one phase shape having at least one local phase width; comparing said at least one local phase width to a minimum phase width metric; and if said local phase width is less than said minimum phase width metric, then assigning to said at least one phase shape a phase shift color that allows more light transmission through said local phase width than an alternate phase shift color.

According to one aspect of the invention, the method further comprises: providing a minimum spacing metric; analyzing said design layout to identify at least one target area where a space dimension between two of said plurality of design shapes is less than said minimum spacing metric; and performing said step of comparing only at said at least one target area.

According to another aspect of the invention, the minimum spacing metric is equal to the minimum phase width metric, or the minimum spacing metric is different than the minimum phase width metric. The minimum phase width metric is preferably about 1.5 to 2.5 times the critical dimension, and more preferably about 2 times the critical dimension. The minimum spacing metric is preferably 2.5 times the critical dimension.

According to yet another aspect of the invention, the method further comprises determining the aspect ratio of the largest local width to the minimum local width of each of said plurality of design shapes, and if said aspect ratio of largest to minimum width is equal to or greater than a predetermined aspect ratio, then identifying a target space between two adjacent ones of said largest local width portion of said design shapes and then performing said step of comparing said at least one local phase width to a minimum phase width metric only for said target space.

The predetermined aspect ratio of largest to minimum width is preferably 2. If the minimum local width is the critical dimension, the predetermined aspect ratio is preferably 2.

The method according to the invention may be implemented in a computer program product comprising a computer useable medium including a computer readable program, wherein the computer readable program when executed on a computer causes the computer to perform the method steps of: providing a design layout comprising a plurality of design shapes having a critical dimension to be printed on a substrate; providing an altPSM layout comprising at least one phase shape disposed between two of said plurality of design shapes, said at least one phase shape having at least one local phase width; comparing said at least one local phase width to a minimum phase width metric; and if said local phase width is less than said minimum phase width metric, then assigning to said at least one phase shape a phase shift color that allows more light transmission through said local phase width than an alternate phase shift color.

The foregoing and other features and advantages of the invention will be apparent from the following detailed description of the invention.

### BRIEF DESCRIPTION OF THE DRAWINGS

Referring to the exemplary drawings wherein like elements are numbered alike in the several figures, in which:

FIG. 1 illustrates a design layout including two design shapes to be printed.

FIG. 2 illustrates phase shifting shapes for an alternating phase shift mask for imaging the design shapes from FIG. 1, including possible corresponding contour lines of images corresponding to said phase shift shapes.

FIG. 3 illustrates a block mask corresponding to the phase shift shapes of FIG. 2 and design shapes of FIG. 1.

FIG. 4 illustrates a possible set of contour lines of images resulting from imaging the phase shift shapes of FIG. 2 and the block mask of FIG. 3.

FIG. 5 illustrates another possible set of contour lines of images resulting from imaging the phase shift shapes of FIG. 2 and the block mask of FIG. 3.

FIG. 6 illustrates a set of phase shapes corresponding to FIG. 2, including biasing.

FIG. 7 illustrates a flow chart of method steps of one embodiment of the invention.

FIG. 8 illustrates a dense layout of design shapes.

FIG. 9 illustrates an embodiment of the invention implemented in computer system and computer program product.

### DETAILED DESCRIPTION OF THE INVENTION

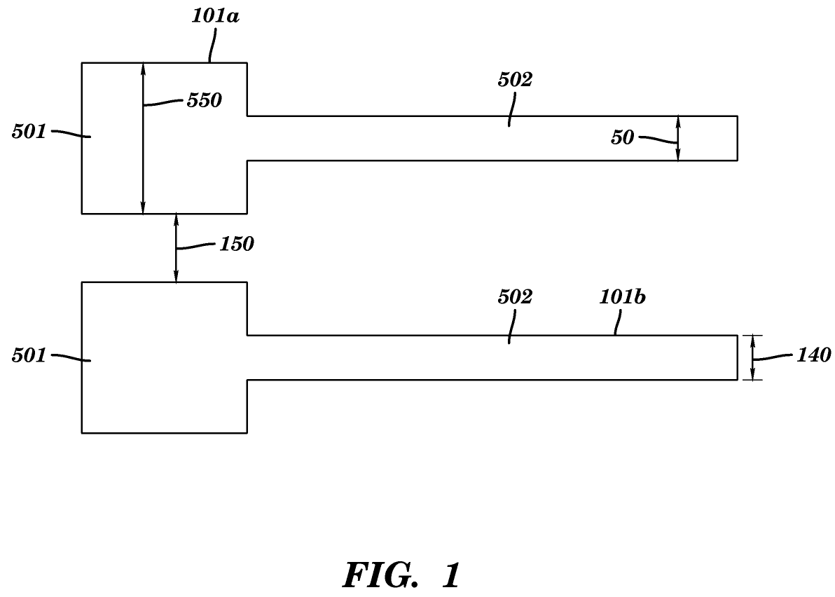

This invention presents a method to identify process sensitive design areas in alternating phase shift mask (altPSM) designs for dense layouts such as SRAMs. In SRAM layouts, many densely spaced shapes having critical dimensions that are to be printed at minimum resolution are laid out in close proximity to each other. For example, in FIG. 1, two such design shapes 101a, 101b are illustrated. However, in altPSM, these shapes are not actually formed on the mask. Rather, the lithography process proceeds in a two step printing process.

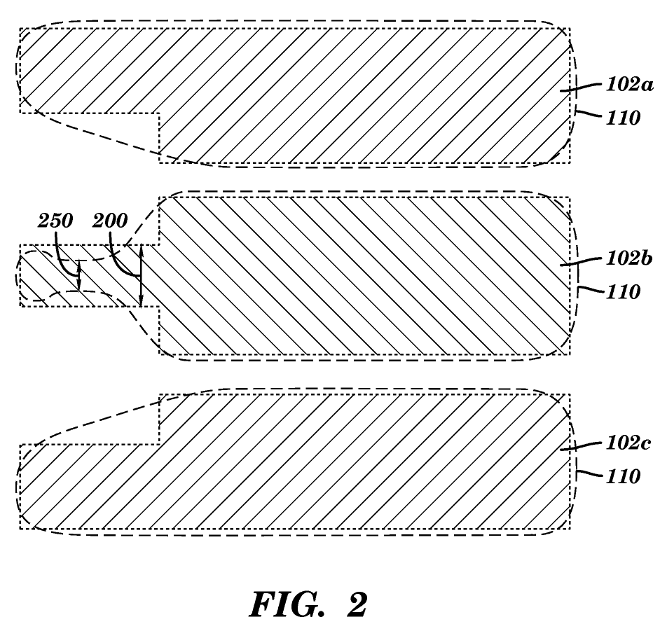

First, the critical features 101a, 101b, each having a portion 502 that has a critical dimension 140, are imaged using a mask having phase shapes of opposite color. For example, as illustrated in FIG. 2, phase shapes 102a and 102c are formed having a first coloring to allow transmission of radiation having first phase characteristics, and a phase shape 102b is formed having a second coloring that allows transmission of radiation that is 180 degrees out of phase relative to the radiation being transmitted through the phase shapes 102a and 102c having first coloring. Contours of resulting image intensity are illustrated as overlain dashed lines 110. Note that the smallest width 250 of the resulting contour 110 may be significantly smaller than the width 200 of the drawn phase shape 102b.

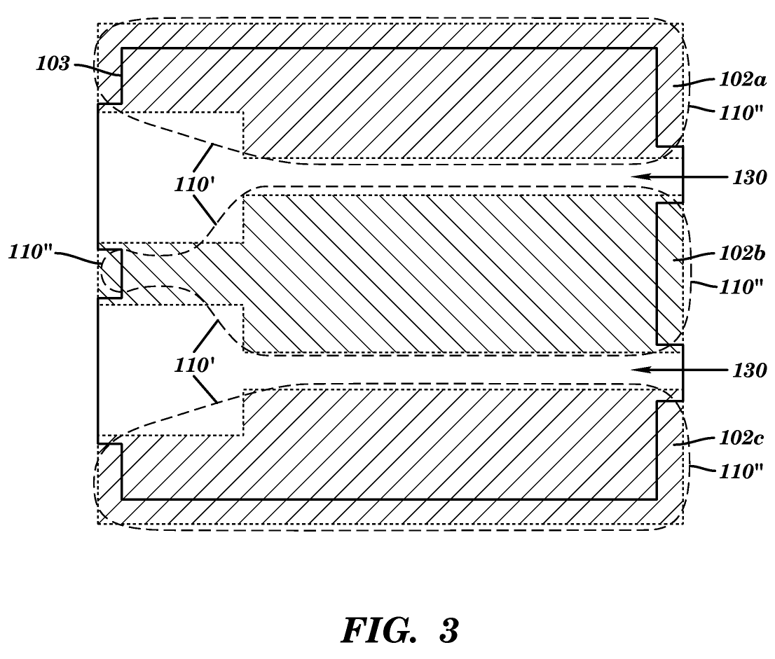

Next, referring to FIG. 3, a block mask 103 is used to protect the critical areas 130 formed from critical portions 110′ of the critical feature images 110, and erase the unwanted portions 110″ of the images 110 resulting from imaging the outer edges of the phase shapes 102a, 102b and 102c.

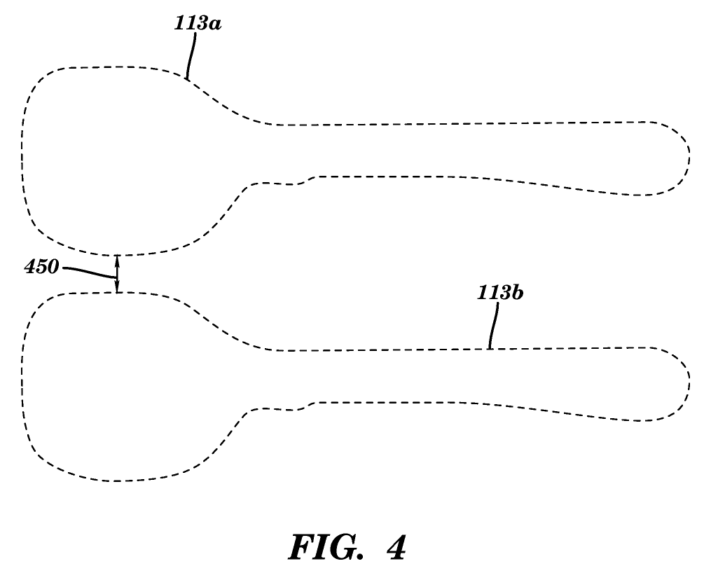

The resulting desired image contours 113a, 113b are illustrated in FIG. 4. It is desirable that there be a minimum spacing 450 between the two printed shapes 113a and 113b.

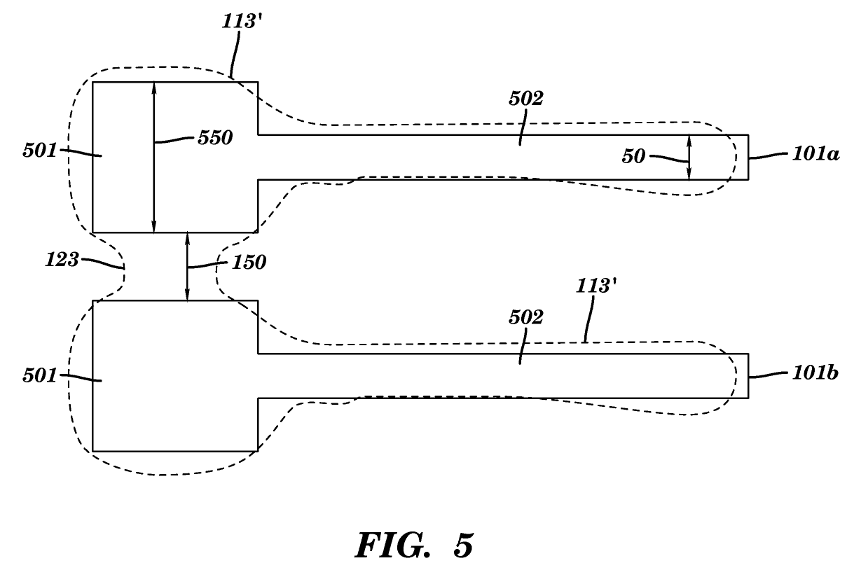

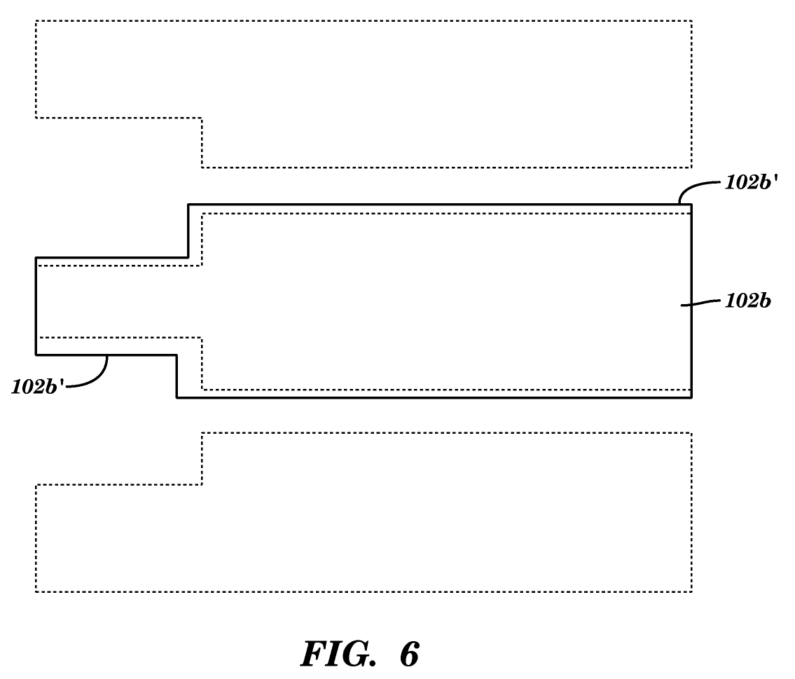

However, referring to FIG. 5, the inventors have observed that if the space 150 between critical features 101a, 101b is sufficiently small, for example, less than about 2.5 times the minimum dimension allowable for a given technology node, for example, a minimum drawn space of about 150 nm between two poly pads 501, which is about 2 times the minimum or critical dimension, for a 60 nm minimum feature technology node, bridging 123 is likely to occur if the phase shape 102b that defines the space 150 between critical features 101a and 101b (see FIG. 2) is a phase shape that allows less light to be transmitted compared to the oppositely colored phase shapes 102a, 102b. For example, in the case of positive resist and dark field mask, 180 degree phase shapes allow less light to be imaged than the 0 degree phase shape, thus causing incomplete resist development, so that bridging is likely to occur. In addition, 180 degree phase shapes require extra processing at the mask house, and therefore the 180 degree shapes are typically prone to larger errors than the 0 degree phase shapes. For example, all phase shapes (0 and 180) are written on one level in the first path of mask writing. Typically, for 180 degree phase shapes, there are 2 extra biases being applied, one to account for phase differential, and the other for the second mask write alignment, which result in bias decorations 102b′ being added to the base 180 degree phase shape 102b, as illustrated in FIG. 6. The extra processing for the 180 degree phase shapes is more sensitive to error and it is to be avoided in a tight space, with a small process window.

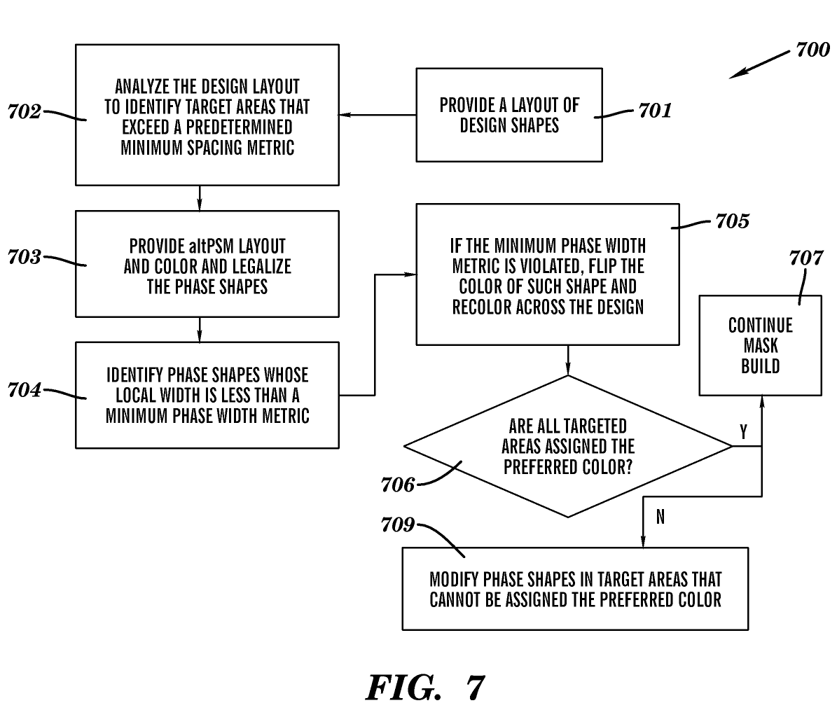

Referring to FIG. 7, one embodiment of the method 700 according to the invention is illustrated, comprising the following steps. First a design layout is provided (Block 701). The designed layout includes shapes that are desired to be printed on the wafer, and will include features having critical dimensions. For example, referring to FIG. 1, desired design shapes 101a and 101b are provided, representing a line 502 having a critical dimension 140 that are required for desired device characteristics. The critical dimension typically corresponds to the smallest dimension that can be printed on the wafer.

Next, the design layout is analyzed to identify areas where the spacing between design shapes may cause problems, according to a predetermined minimum space metric or criterion (Block 702). For example, referring again to FIG. 1, the design shapes 101a and 101b also include wider pad features 501 that are separated by a small spacing 150 between the shapes 101a, 101b. According to one embodiment of the invention, if the smallest space 150 between the pad portions 501 of the design shapes 101a and 101b is less than a predetermined minimum spacing metric, for example, about 1.5 to 2.5 times the critical dimension, more preferably less than about 2 times the critical dimension, then this area is flagged as a potential problem area. According to another embodiment of the invention, the aspect ratio of the widest to the smallest dimension of a design shape is evaluated for target areas of analysis. For example, if the ratio of the largest width 550 of pad features 501 to the smallest width 50 of the line features 502 is equal to or greater than a predetermined aspect ratio, then the spacing 150 between such pad features 501 is further analyzed and compared to a minimum spacing metric and/or minimum phase width metric. In a preferred embodiment, the predetermined aspect ratio is 2, and more preferably 2 times the critical dimension where the minimum width 50 is the critical dimension.

Next, an altPSM mask layout is provided for defining critical feature shapes, and phase shapes are provided to define the critical features. The phase shapes in the mask layout are binary colored and legalized using any method now known in the art or developed in the future (Block 703). Coloring may be assigned without knowledge of design topology and/or preferred phase assignment, as long as the coloring is legalized. Legalization of the coloring ensures that there are oppositely colored phase shapes across each desired critical feature shape in the layout, and that the phase shapes satisfy various rules for design and manufacturability. Methods for coloring and legalizing altPSM layouts are known in art, for example, in co-assigned patents U.S. Pat. No. 6,609,245 (Liebmann et al.) and U.S. Pat. No. 5,883,813 (Kim et al.), the disclosures of which are hereby incorporated by reference in their entirety.

After legalization, the width 200 (see FIG. 2) of the colored phase shapes are analyzed in the identified problem areas (Block 704). If the phase width 200 that defines the minimum space 150 between the desired features to be printed is found to be less than the predetermined minimum phase width metric, this phase shape is marked for a phase assignment switch. For example, according to one embodiment of the invention, if the smallest width 200 of the phase shape is less than about 1.5 to 2.5 times the critical dimension, or more preferably less than about 2 times the critical dimension, then the minimum phase width metric is violated. If this minimum phase width metric is violated, then the coloring assigned to those phase shapes is flipped, and the design is re-colored accordingly (Block 705). Note that the minimum spacing width metric may be the same as the minimum phase width metric, or they may be different. In a preferred embodiment, for example, the minimum spacing width metric is preferably about 2.5 times the critical dimension, while the minimum phase width metric is preferably about 2 times the critical dimension.

The advantage of such a re-coloring is that those narrow phase shapes will be re-colored with a preferred coloring that allows the maximum amount of light transmission through the narrow phase shape. The inventors have found that such a change is sufficient to make the images printable without error. The resulting altPSM mask will have in improved lithographic process window than an altPSM mask where the phase shapes have an alternate phase shift allowing less light in narrow spaces.

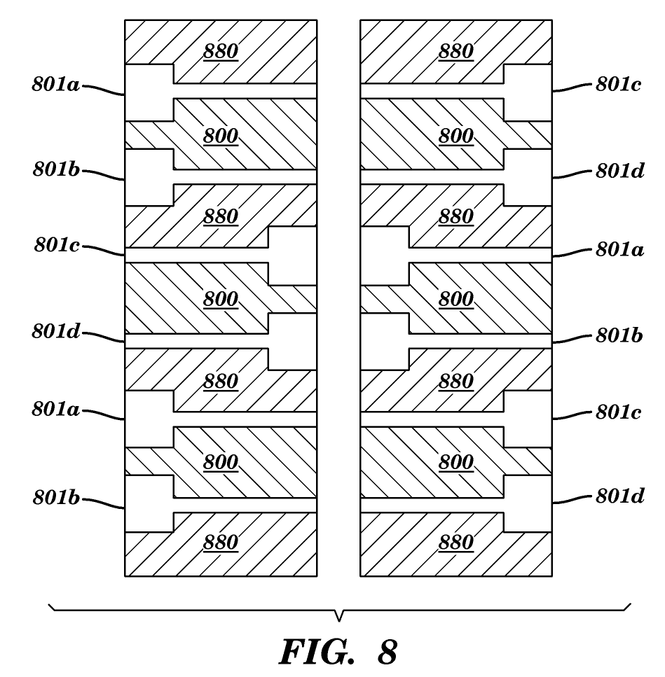

In the case of dense layouts, such as for Static Random Access Memory (SRAM) layouts, such re-coloring is not likely to cause major conflict violations because of the alternate periodicity that is typically used in the placement of densely spaced layouts. Referring to FIG. 8, a pair of similar design elements 801a, 801b is illustrated in a densely spaced layout. For example, in order to achieve a high density, the layout of the pair of elements 801a, 801b is reversed as in the pair of elements 801c, 801d, and placed according to an alternate periodic fashion within the layout. Thus, when the phase shapes are laid out, the phase shapes 800 having the preferred coloring (to allow the most light transmission) will not conflict with the phase shapes 880 having the opposite coloring.

Referring again to FIG. 7, after re-coloring, the altPSM layout is analyzed to evaluate whether all such target phase shapes have been re-colored with the preferred coloring (Block 706). If so, then the mask design and manufacture may continue (Block 707).

It may not be possible to enforce preferred coloring in all such target areas. In such a case, a tailored biasing may be applied to the phase shapes in the area of concern, or other modification of the design shape may be desired (Block 709). This may not provide an optimal solution, but it has the advantage of avoiding a catastrophic failure.

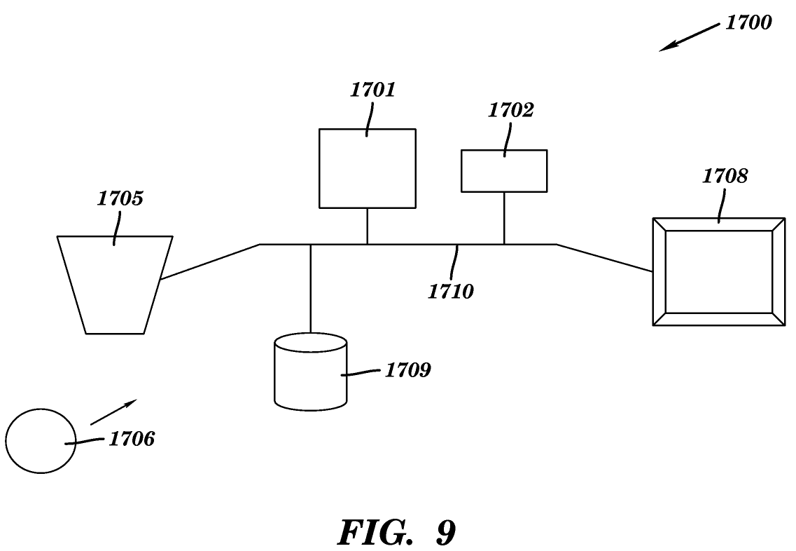

In one embodiment of the present invention, referring to FIG. 9, the geometrical hierarchy may be incorporated into a design tool implemented in a digital computer 1700, having components including, but not limited to: a central processing unit (CPU) 1701, at least one input/output (I/O) device 1705 (such as a keyboard, a mouse, a compact disk (CD) drive, and the like), a display device 1708, a storage device 1709 capable of reading and/or writing computer readable code, and a memory 1702, all of which are connected, e.g., by a bus or a communications network 1710. The present invention may be implemented as a computer program product containing instructions stored on a computer readable medium, such as a tape or CD 1706, which may be, for example, read by the I/O device 1705, and stored in the storage device 1709 and/or the memory 1702. The computer program product contains instructions to cause a computer system to implement the method according to the present invention. The invention can take the form of an entirely hardware embodiment, and entirely software embodiment or an embodiment containing both hardware and software elements. In a preferred embodiment, the invention is implemented in software, which includes, but is not limited to firmware, resident software, microcode, etc. Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus, device or element that can contain, store, communicate, propagate, or transport the program for use by or in connection with the computer or instruction execution system. The medium can be an electronic, magnetic, optical, electromagnetic, infrared, or semiconductor storage medium, network or propagation medium. Examples of a storage medium include a semiconductor memory, fixed storage disk, moveable floppy disk, magnetic tape, and an optical disk. Current examples of optical disks include compact disk-read only memory (CD-ROM), compact disk-read/write (CD-R/W) and digital video disk (DVD). The present invention may also be implemented in a plurality of such a computer or instruction execution system where the present items may reside in close physical proximity or distributed over a large geographic region and connected by a communications network, communicating through a propagation medium via communication devices, such as network adapters. Examples of a network include the Internet, intranet, and local area networks. Examples of a propagation medium include wires, optical fibers, and wireless transmissions. Examples of network adapters include modems, cable modems, ethernet cards and wireless routers.

It is understood that the order of the above-described steps is only illustrative. To this extent, one or more steps can be performed in parallel, in a different order, at a remote time, etc. Further, one or more of the steps may not be performed in various embodiments of the invention.

It is understood that the present invention can be realized in hardware, software, a propagated signal, or any combination thereof, and may be compartmentalized other than as shown. Any kind of computer/server system(s)—or other apparatus adapted for carrying out the methods described herein—is suitable. A typical combination of hardware and software could be a general purpose computer system with a computer program that, when loaded and executed, carries out the respective methods described herein. Alternatively, a specific use computer, containing specialized hardware for carrying out one or more of the functional tasks of the invention could be utilized. The present invention also can be embedded in a computer program product or a propagated signal, which comprises all the respective features enabling the implementation of the methods described herein, and which—when loaded in a computer system—is able to carry out these methods. Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form. Furthermore, it should be appreciated that the teachings of the present invention could be offered as a business method on a subscription or fee basis. For example, the system and/or computer could be created, maintained, supported and/or deployed by a service provider that offers the functions described herein for customers. That is, a service provider could offer the functionality described above

While the present invention has been particularly described, in conjunction with a specific preferred embodiment, it is evident that many alternatives, modifications and variations will be apparent to those skilled in the art in light of the present description. It is therefore contemplated that the appended claims will embrace any such alternatives, modifications and variations as falling within the true scope and spirit of the present invention.

What is claimed:

1. A method of designing an alternating phase shift mask (altPSM) comprising:
providing a design layout comprising a plurality of design shapes having a critical dimension to be printed on a substrate;
providing an altPSM layout comprising at least one phase shape disposed between two of said plurality of design shapes, said at least one phase shape having at least one local phase width;
comparing said at least one local phase width to a minimum phase width metric; and
if said local phase width is less than said minimum phase width metric, then assigning to said at least one phase shape a phase shift color that allows more light transmission through said local phase width than an alternate phase shift color.

2. The method of claim 1, further comprising:
providing a minimum spacing metric;
analyzing said design layout to identify at least one target area where a space dimension between two of said plurality of design shapes is less than said minimum spacing metric; and
performing said step of comparing only at said at least one target area.

3. The method of claim 2, wherein said minimum spacing metric is equal to said minimum phase width metric.

4. The method of claim 2, wherein said minimum spacing metric is different than said minimum phase width metric.

5. The method of claim 1, wherein said minimum phase width metric is about 1.5 to 2.5 times the critical dimension.

6. The method of claim 1, wherein said minimum phase width metric is about 2 times the critical dimension.

7. The method of claim 2, wherein said minimum spacing metric is 2.5 times the critical dimension.

8. The method of claim 1, further comprising determining the aspect ratio of the largest local width to the minimum local width of each of said plurality of design shapes, and if said aspect ratio of largest to minimum width is equal to or greater than a predetermined aspect ratio, then identifying a target space between two adjacent ones of said largest local width portion of said design shapes and then performing said step of comparing said at least one local phase width to a minimum phase width metric only for said target space.

9. The method of claim 8, wherein said predetermined aspect ratio of largest to minimum width is 2.

10. The method of claim 8, wherein said minimum local width is the critical dimension, and said predetermined aspect ratio is 2.

11. A computer program product comprising a computer useable medium including a computer readable program, wherein the computer readable program when executed on a computer causes the computer to perform the method steps of:
providing a design layout comprising a plurality of design shapes having a critical dimension to be printed on a substrate;
providing an altPSM layout comprising at least one phase shape disposed between two of said plurality of design shapes, said at least one phase shape having at least one local phase width;
comparing said at least one local phase width to a minimum phase width metric; and
if said local phase width is less than said minimum phase width metric, then assigning to said at least one phase shape a phase shift color that allows more light transmission through said local phase width than an alternate phase shift color.

12. The computer program product of claim 11, wherein said method steps further comprise:
providing a minimum spacing metric;
analyzing said design layout to identify at least one target area where a space dimension between two of said plurality of design shapes is less than said minimum spacing metric; and
performing said step of comparing only at said at least one target area.

13. The computer program product of claim 12, wherein said minimum spacing metric is equal to said minimum phase width metric.

14. The computer program product of claim 12, wherein said minimum spacing metric is different than said minimum phase width metric.

15. The computer program product of claim 11, wherein said minimum phase width metric is about 1.5 to 2.5 times the critical dimension.

16. The computer program product of claim 11, wherein said minimum phase width metric is about 2 times the critical dimension.

17. The computer program product of claim 12, wherein said minimum spacing metric is 2.5 times the critical dimension.

18. The computer program product of claim 11, wherein said method steps further comprise determining the aspect ratio of the largest local width to the minimum local width of each of said plurality of design shapes, and if said aspect ratio of largest to minimum width is equal to or greater than a predetermined aspect ratio, then identifying a target space between two adjacent ones of said largest local width portion of said design shapes and then performing said step of comparing said at least one local phase width to a minimum phase width metric only for said target space.

19. The computer program product of claim 18, wherein said predetermined aspect ratio of largest to minimum width is 2.

20. The computer program product of claim 18, wherein said minimum local width is the critical dimension, and said predetermined aspect ratio is 2.
